(19) United States
(12) Patent Application Publication
(10) Pub. No.: US 2026/0054787 A1
(43) Pub. Date: Feb. 26, 2026

(54) Trailer Mounted Drive System

(71) Applicant: Vincent Loccisano, Wellesley, MA (US)

(72) Inventor: Vincent Loccisano, Wellesley, MA (US)

(21) Appl. No.: 18/812,653

(22) Filed: Aug. 22, 2024

(51) Int. Cl. B62D 59/04; B60D 1/06; B60D 1/58; B60D 1/66; B60L 7/10; B60L 15/20; B60L 50/60; B60R 16/023

(52) U.S. Cl. CPC B62D 59/04; B60D 1/58; B60D 1/665; B60L 7/10; B60L 15/20; B60L 50/60; B60R 16/0231; B60D 1/06; B60L 2200/28

(57) ABSTRACT

An example embodiment is a trailer for a passenger vehicle configured to sense load and direction of trailer movement by way of sensors in the trailer hitch. Sensors may be in the ball of the trailer hitch or in the trailer tongue, or in both. Sensors may include proximity sensors, accelerometers, strain gauges, and pressure transducers.

### TECHNICAL FIELD

The present disclosure relates generally to devices, systems and methods for towing trailers with non-tractor trailer vehicles. (I think this is applicable to all non-semi trailers (as the range guys captured that) but that does not mean passenger vehicles only)

### BACKGROUND OF THE INVENTION

Because they are heavy to tow, trailers require towing vehicles that have a minimum frame strength, suspension and braking capacity. A passenger vehicle may have a tow hitch for towing utility trailers, boat trailers and appropriately sized recreational vehicles.

Both electric vehicles and internal-combustion engine trucks can tow a trailer, but often these vehicles (it can be IC or electric) lack sufficient towing or braking capacity, or have insufficient wheelbase or vehicle weight to properly tow larger trailers without having issues stopping or controlling trailer sway. When a trailer exceeds a vehicle's towing capacity, problems arise in vehicle-handling, potentially causing damage to tires or suspension, trouble with unintended and unsafe sway in the trailer or the tow vehicle or in difficulty stopping. Pulling a trailer up a hill may cause strain on the vehicle engine and transmission causing the vehicle to overheat while towing downhill may result in exceeding the vehicles braking capacity.

As a general rule, loading a trailer requires placing 60% of the load ahead of the trailer's axle. With most of the load fore of the axle, weight on the trailer hitch provides traction to the rear wheels of the towing vehicle. If, however, most of the weight is placed behind the trailer's axle, a lifting force can result on the trailer hitch, which can reduce the towing vehicle's traction, potentially leading to trailer-sway.

Trailer sway (or “trailer fishtailing”) occurs when a trailer begins to move from side to side. Trailer sway can cause a trailer to overturn, and potentially both trailer and vehicle to be overturned. Trailer sway can occur when a towed load rounds a curve; or it may be initiated by a side wind. Attempting to correct the sway by counter-steering only increases the trailer sway.

A trailer hitch is a configuration in which a trailer's “tongue” mounts on a towing vehicle's tow ball such that the tongue may swivel on the tow ball without unintentionally releasing from it.

Automobile electronics, including computers, electrical cables, and software protocols, are together known as a controller-area network (CAN), or CAN bus. A CAN is a vehicle's main computer system. Through the CAN bus, data travels through the system to the many subsystems such as those controlling the engine, the transmission, doors, windows, and other subsystems. Each of these subsystems is controlled by an electronic control unit (ECU). Electric vehicles may have fifty or more ECUs, each able to sense signals indicating, for example: acceleration at various angles; voltage; pressure; braking; vehicle roll and yaw; steering angle; temperature, and other variables. The CAN bus routes signals from sensors to computers as communicated by each ECU. An ECU can monitor voltage used by a subsystem and communicate that information through the CAN bus to actuate, for instance, stopping a power-sliding door from closing on a passenger's limb, or adjusting a fuel injector's performance.

Adding to or changing a vehicle's electronic features once required extensive wiring. With the development of CAN in the last forty years, feature development (such as adding passenger-controlled climate options) has become physically easier because each new feature can now be added by programming the new computer code into the CAN. Now, all vehicle features as well as vehicle diagnostics are controlled via CAN, which uses a standardized protocol called OBD-II. New features can be integrated into an EV by developing and uploading an algorithm into the vehicle's CAN.

Vehicle computer networks are now evolving to work with other network protocols, including Local Interconnect Networks (LIN) and FlexRay, which are network protocols designed for vehicles, as well as Ethernet.

There is a need for a trailer and trailer hitch-related apparatus that mitigates trailer sway while assisting in powering and stopping a trailer, thereby offering increased towing capacity to existing vehicles along with increased control and safety for both the tow vehicle and the trailer.

### SUMMARY OF THE INVENTION

An example embodiment is a trailer for a passenger vehicle configured to sense load and direction of trailer movement by way of sensors in the trailer hitch. Sensors may be in the ball of the trailer hitch or in the trailer tongue, or in both. Sensors may include proximity sensors, accelerometers, strain gauges, and pressure transducers.

Some embodiments of the presented invention include a trailer-mounted drive system. The trailer-mounted drive system is designed for both acceleration and deceleration of a trailer. In an example embodiment, a single electric motor powers independent drive shafts to each wheel, and may be configured to provide power or regenerative braking to each wheel independently. In another embodiment, a motor/generator is mounted in at least one wheel, on each side of the trailer, providing power and regenerative braking to each wheel independently. Signals from sensors in the trailer tongue and/or tow ball communicate with a controller that interprets the signals to engage a drive train to independently control the velocity of trailer wheels.

Trailer sway may be reduced or eliminated by measuring the rotational velocity of each trailer wheel or the acceleration characteristics of the trailer or tow vehicle and then independently controlling trailer wheel speed to equalize the eliminate or counter trailer sway.

In some embodiments, an electrical cable carries both power and information between a tow vehicle and the trailer drive train.

A controller interprets information from sensors in the tow hitch and sends signals to a display that is readable by a driver. Signals from sensors in the tow hitch may be interpreted by the controller to determine either excessive or deficient load on the trailer tongue and tow ball; the onset of trailer sway; and the amount of force required to move or stop the trailer. Excessive or deficient load on the trailer tongue may, for example, be converted to a warning to the driver that there is an unbalanced load on the trailer. Signals from pressure transducers, alternately from both sides of the tow ball, or from strain gauges on opposite sides of the trailer tongue, may be interpreted as the onset of trailer sway. Sensors fore, or fore and aft, of the tow ball may determine the force required to move or stop the trailer. Power may then be sent to the motor generator to engage one or more motors to drive the trailer when the user accelerates the vehicle, or, when the user slows the vehicle, may be used to engage the drive train as a generator to provide regenerative braking.

In one embodiment, a battery bank for powering the motor(s), and for storing energy produced in regenerative braking is mounted on the trailer. A battery bank of this sort is useful when using the embodiment with an internal-combustion engine (ICE) vehicle because power may be transferred slowly from an ICE engine's alternator to charge the battery bank. Alternatively, an independently powered trailer may be moved about without the assistance of a tow vehicle.

In another embodiment, power is transferred to and from a battery bank in an electric vehicle (EV) to the trailer power train. Energy derived from the trailer power train during regenerative braking may be transferred to the electric-vehicle batteries. An electric vehicle coupled with an example embodiment becomes effectively a six-or-more wheeled vehicle with power and braking capabilities. Integration into an EV CANbus and ECU enables the EV information systems to respond to signals from a controller that is coupled with the trailer drive train. For example, the trailer drive train may mimic acceleration, deceleration, and torque of the EV by coupling signals from the EV accelerator, brake and speedometer. The EV touch screen may show alerts that signal excessive or deficient trailer-tongue loading. In the event of trailer sway, an algorithm in the controller applies regenerative braking to individual wheels while reducing EV engine torque to equalize rotational velocity of wheels on either side of the trailer to stabilize a swaying trailer. When the trailer sway reduction algorithm initiates, alerts are sent to the driver.

A hand tool has a wheel and tow ball. The tow ball links with the tongue of a powered trailer equipped with onboard batteries. A controller is configured to receive signals from sensors in the tongue and ball hitch and to calculate a response that controls the motion of the trailer. Pressure on the forward sensor signals the controller to engage the drive train to power the trailer forward. Pressure on the rearward sensor signals the power train to apply regenerative brakes. Pressure on side sensors sends signals to the controller to power one side of the drive train to turn the trailer in the direction of the sensor that is receiving pressure.

### BRIEF DESCRIPTION OF DRAWINGS

FIG. 1 is a perspective view of an example embodiment.

FIG. 2 is a is a perspective, detail view illustrating an aspect of the embodiment.

FIG. 3 is a top, detail view thereof.

FIG. 4 is a is a perspective view of an iteration of the embodiment.

FIG. 5 is a perspective view of an iteration of the embodiment.

FIG. 6 is a perspective view of an iteration of the embodiment.

### DETAILED DESCRIPTION

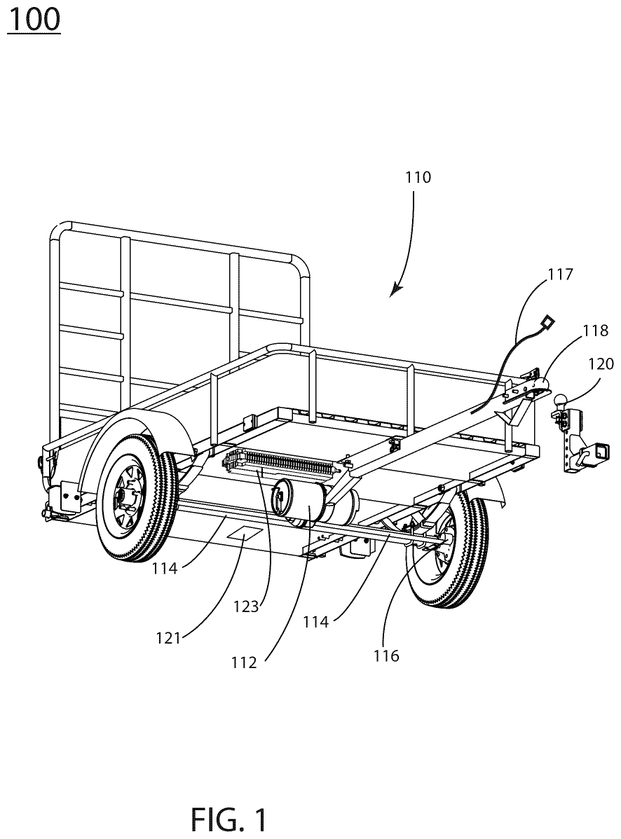

FIG. 1 is a perspective view of an example embodiment 100. A trailer 110 is equipped with a motor/generator 112 that is coupled with each wheel 116 by way of drive shafts 114. In one embodiment, the motor/generator 112 is coupled with a controller 121. A trailer tongue 118 is configured to couple with a tow ball 120.

In one embodiment, a battery bank 123 is mounted to the trailer. Electrical energy stored in the battery bank powers the motor, and electricity generated by regenerative braking through the motor/generator 112 is stored in the battery bank 123.

In another embodiment, a motor generator and controller communicate with the electrical systems of an electric vehicle (EV) through a cable 117.

Electrical energy from an EV battery bank powers the motor/generator 112 to control the wheels, and when engaged to provide regenerative braking, the motor/generator 112 provides resistance against the motion of the trailer wheels 116, and sends electrical energy to the EV battery bank through cable 117.

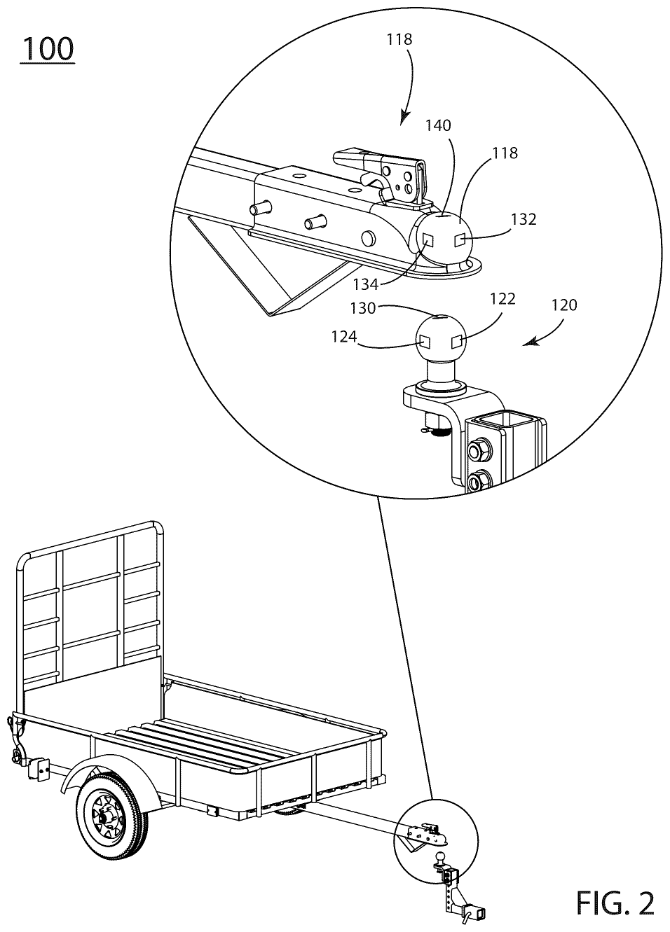

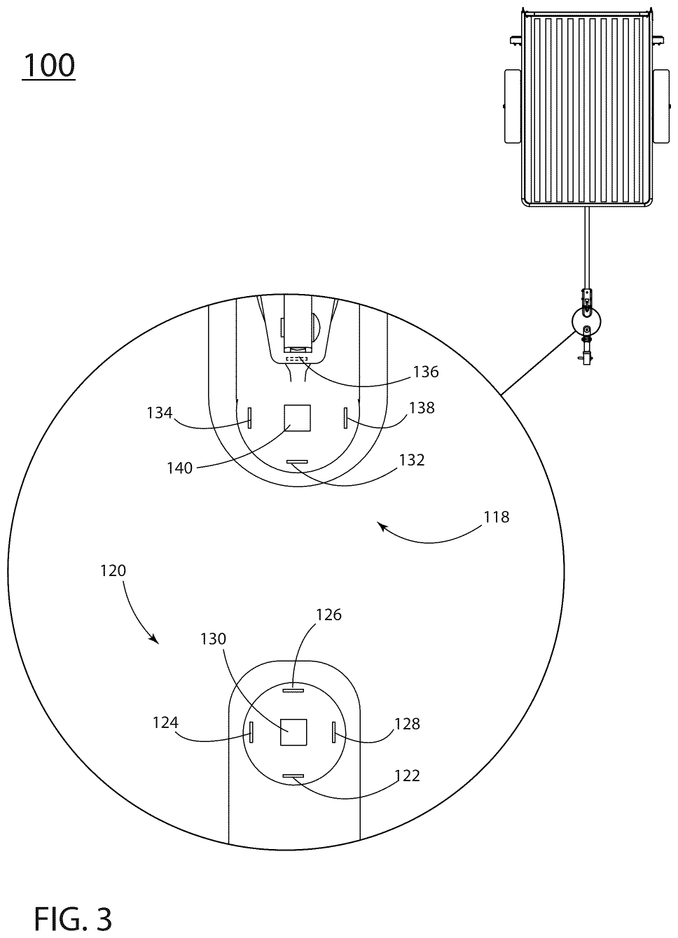

FIG. 2 is a detail, perspective view and FIG. 3 a detail, top view of an example trailer tongue 118 and tow ball 120. Sensors on the tow ball and on/or the tongue generate signals from the movement of the tow ball in the tongue, and send those signals to a controller. One skilled in the art understands that a single sensor may generate and send signals to a controller that may employ a protocol to interpret those signals to determine relative motions of the trailer relative to the tow vehicle.

In one embodiment, when the tow ball is engaged with the tongue, a forward tow ball sensor 122 is configured to output signals representing forward forces applied to the tow ball. A rearward tow ball sensor 126 is configured to output signals representing rearward forces on the tow ball. A left tow ball sensor 128 is configured to output signals representing leftward forces on the tow ball. A right tow ball sensor 124 is configured to output signals representing rightward forces on the tow ball. In this configuration, the sensors in the tow ball are electrically coupled with the controller.

In another embodiment, when the tow ball is engaged with the tongue, a forward tongue sensor 132 is configured to output signals representing forward forces applied to the tongue. A rearward tongue sensor 136 is configured to output signals representing rearward forces applied to the tongue. A left tongue sensor 138 is configured to output signals representing leftward forces applied to the tongue. A right tongue sensor 134 is configured to output signals representing rightward forces applied to the tongue. In this configuration, the sensors in the tongue are electrically coupled with the controller.

A controller includes a central processing unit with a protocol that interprets the signals to determine the position and forces exerted on the tow ball 120 by the tongue 118. Sensors generate signals that may be used to determine tongue weight with respect to the tow ball and the force exerted between tow ball and tongue left, right, forward or rearward. The resultant information may be used to detect a trailer with too little tongue weight, posing a sway hazard, or too much tongue-weight, posing damage to the tow vehicle suspension. The controller may also interpret signals denoting a rearward force wherein signals may be sent from the controller to the motor/generator to decelerate the trailer by engaging regenerative braking; or a forward force denoting a need to power the trailer to reduce strain on the tow vehicle. The controller may further interpret repeated signals from sensors left and right on the tow ball and/or tongue as the onset of trailer sway. The controller may then send signals to the motor/generator to initiate a braking sequence to mitigate trailer sway.

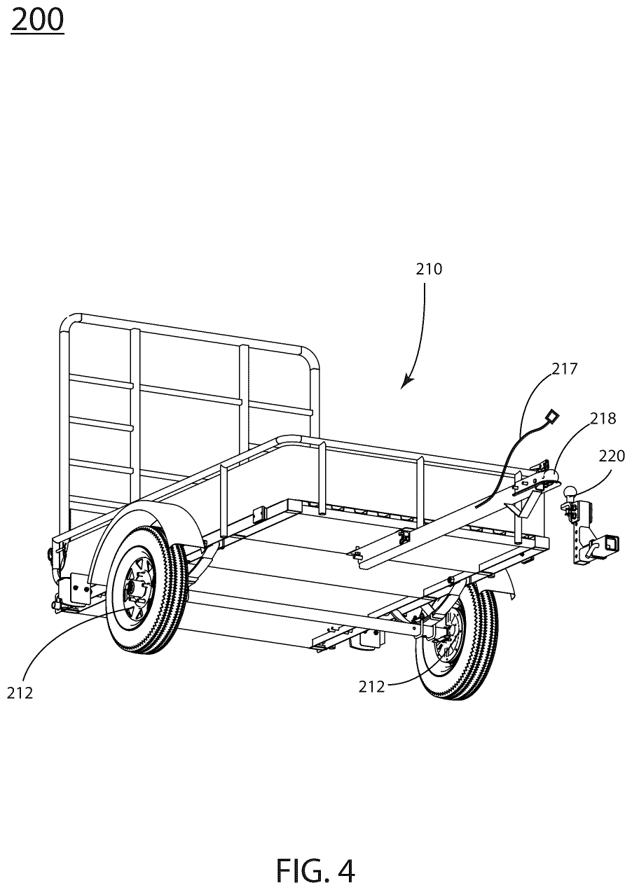

FIG. 4 is a perspective view of an example embodiment 200. A trailer 210 is equipped with wheel-mounted motor/generators 212, one in each wheel. The motor/generators 212 are coupled with the electrical systems of an electric vehicle (EV) through a cable 217. A trailer tongue 218 is configured to couple with a tow ball 220. In one embodiment, sensors in the tow ball communicate with an EV protocol to control the trailer similar to that described in FIG. 2 and FIG. 3. In another embodiment, sensors in the trailer tongue communicate with an EV protocol to control the trailer in a manner similar to that described in FIG. 2 and FIG. 3. One skilled in the art understands that an example trailer such as embodiment 200 may function with a controller battery bank, or may be coupled with the electronics and battery bank of an EV to perform the same functions.

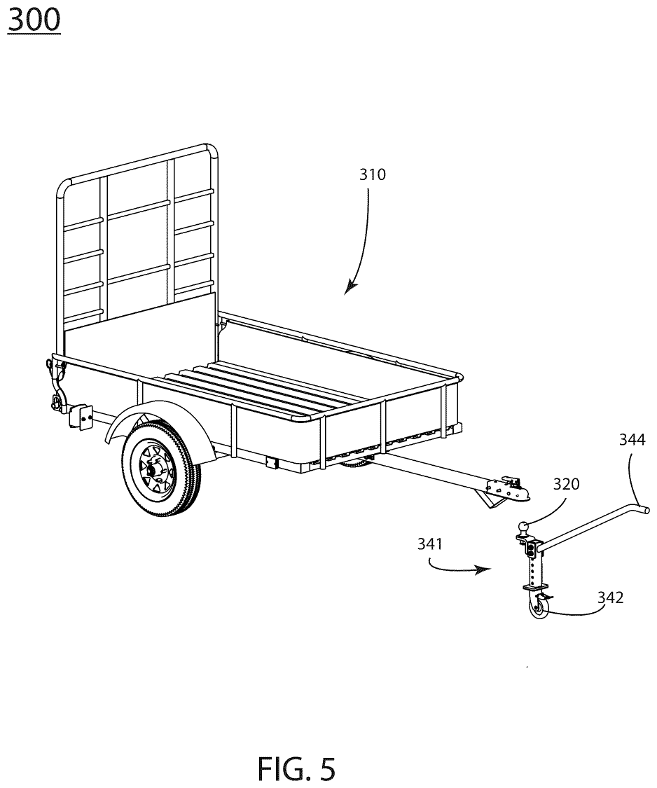

FIG. 5 is an illustration of another embodiment 300. A trailer 310 is similar to a trailer described in FIG. 1, FIG. 2, FIG. 3 or FIG. 4, having an on-board battery bank and sensors as described in FIG. 2 and FIG. 3. A handle-operated tow ball 341 has a handle 344, a tow ball 320 and a caster wheel 342. Sensors in the tongue as described in FIG. 2 and FIG. 3 detect movement of the tow ball. When the tow ball is moved forward, forward sensors signal the controller to move the wheels forward. When the tow ball is moved rearward, sensors signal the controller to move the wheels rearward. Movement of the tow ball to the left signals the controller to effect a left turn, braking the left wheel and powering the right wheel. Movement of the tow ball to the right signals the controller to to effect a right turn, braking the right wheel and powering the left wheel. The trailer may be moved about in this manner.

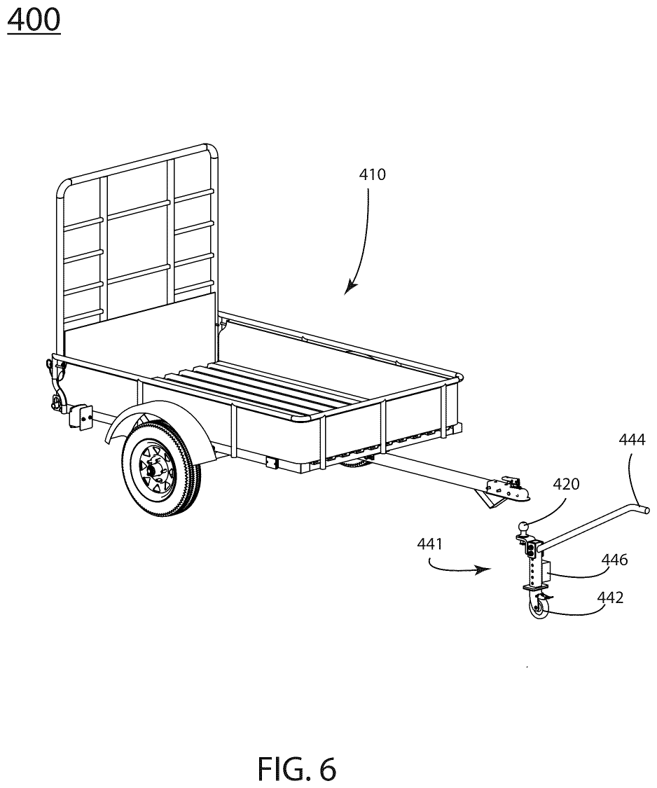

FIG. 6 is an illustration of another embodiment 400. A trailer 410 is similar to a trailer described in FIG. 1, FIG. 2, FIG. 3 or FIG. 4, without an on-board battery bank and with an electrical and information transmitting cable 217 configured to connect to an electric vehicle CAN bus and battery bank. The embodiment 400 further has sensors as described in FIG. 2 and FIG. 3. A handle-operated tow ball 441 has a handle 444, a tow ball 420 and a caster wheel 442. A battery 446 is affixed to the handle apparatus. Sensors in the tongue as described in FIG. 2 and FIG. 3 detect movement of the tow ball. When the tow ball is moved forward, forward sensors signal the controller to send electricity from the battery 446 to power the motor/generator to move the wheels forward. When the tow ball is moved rearward, sensors signal the controller to send electricity to the motor/generator(s) to move the wheels rearward. Movement of the tow ball to the left signals the controller to effect a left turn, braking the left wheel and powering the right wheel. Movement of the tow ball to the right signals the controller to to effect a right turn, braking the right wheel and powering the left wheel. The trailer may be moved about in this manner.

1. A trailer comprising:
a tongue configured to pivotally engage with a tow ball; and
at least a first motor/generator fixedly engaged with the trailer wherein the motor/generator is rotationally engaged with at least a first wheel on a first side of the trailer; and
an array of sensors fixedly engaged with the tongue configured to measure at least a forward and rearward force exerted on the tongue by the tow ball; and
a controller having a central processing unit storing instructions electrically coupled with said array of sensors; wherein
the instructions interpret signals from the sensors to send electrical energy from the battery bank to the motor to power the trailer forward when signals are received signifying a forward force on the tongue; and said instructions interpret signals from the sensors to send electrical energy from the battery bank to the motor to power the trailer rearward when signals are received signifying a rearward force on the tongue.

2. The trailer of claim 1 wherein:
at least a second motor/generator rotationally engaged with at least a second wheel on a second side of the trailer.

3. The trailer of claim 1 further comprising:
a battery bank disposed about the trailer and electrically coupled to the at least a first motor/generator.

4. The trailer of claim 1 further comprising:
a battery bank disposed within a tow vehicle the trailer and electrically coupled to the at least a first motor/generator.

5. The trailer of claim 2 wherein;
said array of sensors in the tongue is configured to measure lateral motion; wherein repeated lateral motion from opposite sides of the tongue is interpreted by said instructions as an onset of sway wherein regenerative braking on each relatively faster wheel mitigates trailer sway.

6. The trailer of claim 1 wherein:
said sensors are pressure transducers.

7. The trailer of claim 1 wherein:
said sensors are proximity sensors.

8. The trailer of claim 1 wherein:
said sensors are strain gauges.

9. The trailer of claim 1 wherein:
the sensors are a combination of proximity sensors and pressure transducers.

10. The trailer of claim 3 further comprising:
an apparatus having a handle and a towball and at least one caster wheel; and
the tow ball rotationally engaged with the tongue, engages with the sensors in the tongue; wherein
signals from sensors interpreted by said controller as a forward force exerted on the tongue by the tow ball, direct electricity from the battery bank to the at least one motor/generator to power the trailer forward and signals from sensors interpreted by said controller as a rearward force exerted on the tongue by the tow ball, direct electricity from the battery to power the trailer rearward.

11. The trailer of claim 5 further comprising:
an apparatus having a handle and a tow ball and at least one caster wheel; and
a battery bank disposed about the trailer and electrically coupled to the at least a first motor/generator and the at least a second motor/generator; and
the tow is ball rotationally engaged with the tongue, and in communication with the sensors in the tongue; and
the sensors in the tongue are electrically coupled to the controller; wherein
signals from sensors interpreted by said controller as a lateral force exerted on the tongue by the tow ball, direct electricity from the battery bank to one of said motor/generators, to turn the tongue in the direction of the lateral force.

12. A trailer comprising:
a tongue configured to pivotally engage with a tow ball; and
at least a first motor/generator rotationally engaged with at least a first wheel on a first side of the trailer; and
at least a second motor/generator rotationally engaged with at least a second wheel on a second side of the trailer; and (same as above, this second motor can be part of a dependent claim)
a first cable configured to carry electrical energy to and from a battery bank in said electric vehicle and said at least a first motor/generator and said at least a second motor/generator; and
an array of sensors fixedly engaged with the tow ball configured to measure at least a forward and rearward force exerted on the tow ball; and
said first cable is configured to carry information between said array of sensors and a CAN bus in said electric vehicle; and
a set of instructions stored in said electric vehicle CAN bus configured to receive signals from said array of sensors; wherein
the instructions interpret signals from the sensors signifying a rearward force on the tow ball and in turn send electrical energy from the electric vehicle battery bank to said at least a first motor/generator and to said at least a second motor/generator to power the trailer forward; and said instructions interpret signals from the sensors signifying a forward force on the tow ball and in turn engage regenerative braking in the at least a first motor/generator and in said at least a second motor/generator.

13. The trailer of claim 12 further comprising:
said array of sensors fixedly engaged with the tow ball are configured to measure lateral force exerted on the tow ball; wherein
sensors sending signals signifying repeated lateral motion from opposite sides of the tongue is interpreted by said instructions in said controller as an onset of sway wherein regenerative braking on each relatively faster wheel mitigates trailer sway.

14. The trailer of claim 13 wherein:
said sensors are pressure transducers.

15. The trailer of claim 13 wherein:
said sensors are proximity sensors.

16. The trailer of claim 13 wherein:
said sensors are strain gauges.

17. The trailer of claim 13 wherein:
the sensors are a combination of proximity sensors and pressure transducers.

18. The trailer of claim 12 further comprising:
a handle engaged with said towball having at least one caster wheel; and
a battery fixedly engaged with said handle; and
a second cable configured to carry electrical energy to and from the battery and said at least a first motor/generator and said at least a second motor/generator; and
a controller storing said instructions fixedly engaged proximal to said battery; and
when rotationally engaged with the tongue, said sensors engaged with the tow ball send signals to said controller which in turn engages said battery to send electricity through said second cable and said first cable ; wherein
signals from sensors interpreted by said controller as a rearward force exerted on the tow ball, direct electricity from the battery to the first motor/generator and the second motor/generator to power the trailer forward; and
signals from sensors interpreted by said controller as a rearward force exerted on the tongue by the tow ball, direct electricity from the battery to power the trailer rearward.

19. The trailer of claim 13 further comprising:
a handle operated towball having a handle and a towball and at least one caster wheel; and
the tow ball rotationally engaged with the tongue, and sensors in the tow ball movably engaged with the tongue generate signals; wherein
signals from sensors interpreted by said controller as a lateral force exerted on the tongue by the tow ball, direct electricity from the battery to one motor/generator to turn the tongue in the direction of the lateral force.
